(19) United States
(12) Patent Application Publication
(10) Pub. No.: US 2020/0175807 A1
(43) Pub. Date: Jun. 4, 2020

(54) SYSTEMS, METHODS, AND DEVICES FOR A PROGRESSIVE JACKPOT FOR A LOTTERY GAME

(71) Applicant: IGT Global Solutions Corporation, Providence, RI (US)

(72) Inventor: Eric LANCASTER, Las Vegas, NV (US)

(73) Assignee: IGT Global Solutions Corporation

(21) Appl. No.: 16/206,786

(22) Filed: Nov. 30, 2018

(51) Int. Cl. G07F 17/32

(52) U.S. Cl. CPC G07F 17/329; G07F 17/3223; G07F 17/3258

(57) ABSTRACT

A lottery server system receives lottery entry messages for lottery tickets from lottery terminals, each lottery ticket including a plurality of game elements for a primary lottery game and a unique identifier for a secondary lottery game. A first portion of a wager associated with the lottery entry message is credited to a secondary prize pool for the secondary lottery game and the processor circuit determines when a triggering condition has been satisfied by content of one of the lottery entry messages for one of the lottery tickets. If the triggering condition has been satisfied for a particular lottery ticket, a secondary lottery game result is generated based on the unique identifier of the lottery ticket, independently of the plurality of game elements for the primary lottery game, and a portion of the secondary prize pool may be selectively awarded to a holder of the lottery ticket.

### BACKGROUND

Embodiments described herein relate to systems, methods, and devices for lottery tickets, and in particular for providing a progressive jackpot for a lottery game. Historically, lottery games have a payout percentage that may be lower than a payout percentage for other competing games, such as slot machine or casino games. Because of this relatively low payout percentage, many potential players may be disinclined to participate. For example, many demographics, particularly younger players, focus their participation on either low-level scratch off play, with frequent, but small payouts, or wide area jackpots, particularly when the potential jackpot is extremely large. Between these two extremes, there is relatively low participation among certain demographics. It is also difficult to increase the payout percentage for many lottery games without decreasing the expected revenue and profitability for those games. As a result, it may be difficult to increase participation in lottery games among certain demographics without upsetting the underlying financial expectations of those games.

### BRIEF SUMMARY

According to one embodiment, a lottery server system includes a server processor circuit, and a server memory coupled to the server processor circuit. The server memory includes machine-readable instructions that, when executed by the server processor circuit, cause the server processor circuit to receive lottery entry messages for lottery tickets from lottery terminals, each lottery ticket comprising a plurality of game elements for a primary lottery game and a unique identifier for a secondary lottery game, wherein a primary game result for the primary lottery game is based on the plurality of game elements independently of the unique identifier for the secondary lottery game. The machine-readable instructions further cause the server processor circuit to, based on receipt of each of the lottery entry messages, credit a first portion of a wager associated with the lottery entry message to a secondary prize pool for the secondary lottery game. The machine-readable instructions further cause the server processor circuit to determine when a triggering condition has been satisfied by content of one of the lottery entry messages for one of the lottery tickets. The machine-readable instructions further cause the server processor circuit to, in response to determining that the triggering condition has been satisfied for a particular one of the lottery entry messages, generate, independently of the plurality of game elements for the primary lottery game, a secondary lottery game result for the secondary lottery game based on the unique identifier of the lottery ticket associated with the particular one of the lottery entry messages. The machine-readable instructions further cause the server processor circuit to, based on the secondary lottery game result indicating a secondary lottery game win, selectively transmit an award message comprising an instruction to award a portion of the secondary prize pool to a holder of the lottery ticket associated with the particular one of the lottery entry messages.

According to another embodiment, a method is disclosed. The method includes receiving lottery entry messages for lottery tickets from lottery terminals, each lottery ticket comprising a plurality of game elements for a primary lottery game and a unique identifier for a secondary lottery game, wherein a primary game result for the primary lottery game is based on the plurality of game elements independently of the unique identifier for the secondary lottery game. The method further includes, based on receipt of each of the lottery entry messages, crediting a first portion of a wager associated with the lottery entry message to a secondary prize pool for the secondary lottery game. The method further includes determining when a triggering condition has been satisfied by content of one of the lottery entry messages for one of the lottery tickets. The method further includes, in response to determining that the triggering condition has been satisfied for a particular one of the lottery entry messages, generating, independently of the plurality of game elements for the primary lottery game, a secondary lottery game result for the secondary lottery game based on the unique identifier of the lottery ticket associated with the particular one of the lottery entry messages. The method further includes, based on the secondary lottery game result indicating a secondary lottery game win, selectively transmitting an award message comprising an instruction to award a portion of the secondary prize pool to a holder of the lottery ticket associated with the particular one of the lottery entry messages.

According to another embodiment, a lottery terminal is disclosed. The lottery terminal includes an input device, an electronically controlled dispenser apparatus, a processor circuit, and a memory coupled to the processor circuit. The memory includes machine-readable instructions that, when executed by the processor circuit cause the processor circuit to receive, at the input device, an indication of a wager for a lottery ticket, the lottery ticket comprising a plurality of game elements for a primary lottery game and a unique identifier for a secondary lottery game, wherein a primary game result for the primary lottery game is based on the plurality of game elements independently of the unique identifier for the secondary lottery game. The machine-readable instructions further cause the processor circuit to, in response to receiving the indication of the wager, transmit a lottery entry message comprising the unique identifier to a lottery server. The machine-readable instructions further cause the processor circuit to, in response to the lottery server crediting a portion of the wager to a secondary prize pool for a secondary game based on the lottery entry message and determining that a triggering condition has been satisfied for the lottery entry message, receive, from the lottery server, an award message comprising an instruction to award a portion of the secondary prize pool to a holder of the lottery ticket. The machine-readable instructions further cause the processor circuit to, in response to receiving the award message, dispense, via the electronically controlled dispenser apparatus, a physical item redeemable for a monetary value based on the portion of the secondary prize pool.

### BRIEF DESCRIPTION OF THE DRAWINGS

FIG. 1 is a schematic block diagram illustrating a network configuration for a lottery network including a plurality of lottery terminals according to some embodiments.

FIG. 2 illustrates a lottery ticket having a primary lottery game having a plurality of game elements and a secondary lottery game having a progressive jackpot feature, according to some embodiments.

FIGS. 3A and 3B illustrate a graphical user interface (GUI) for providing a progressive jackpot feature at a lottery terminal according to some embodiments.

FIG. 4 is a flowchart illustrating operations of systems/methods according to some embodiments.

FIG. 5 is a schematic block diagram illustrating an electronic configuration for a computing device according to some embodiments.

### DETAILED DESCRIPTION

Embodiments described herein relate to systems, methods, and devices for lottery tickets, and in particular for providing a progressive jackpot for a lottery game. In some embodiments, a lottery server system may receive lottery entry messages for lottery tickets from lottery terminals, each lottery ticket including a plurality of game elements for a primary lottery game and a unique identifier for a secondary lottery game. A first portion of a wager associated with the lottery entry message may be credited to a secondary prize pool for the secondary lottery game and the processor circuit determines when a triggering condition has been satisfied by content of one of the lottery entry messages for one of the lottery tickets. If the triggering condition has been satisfied for a particular lottery ticket, a secondary lottery game result may be generated based on the unique identifier of the lottery ticket, independently of the plurality of game elements for the primary lottery game, and a portion of the secondary prize pool may be awarded to a holder of the lottery ticket.

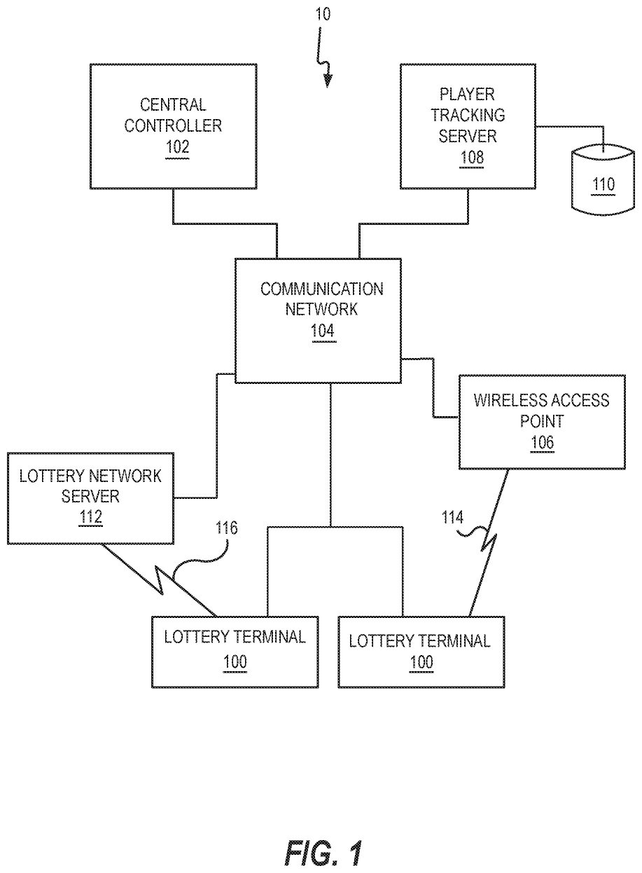

Referring now to FIG. 1, a lottery server system 10 including a plurality of lottery terminals 100 is illustrated. The system 10 includes a communication network 104 for managing lottery network communications. Communications on the communications network 104 may be managed by a central controller 102. The communications network 104 may be a private data communication network that is operated, for example, by the lottery entity that operates the lottery terminals 100, or may be connected to a publicly accessible network (e.g., the Internet). Communications over the communications network 104 may be encrypted for security. The central controller 102 may be any suitable server or computing device which includes at least one processor circuit (such as a microprocessor or other processor, for example) and at least one memory or storage device. Each lottery terminal 100 may include a processor circuit that transmits and receives events, messages, commands or any other suitable data or signal between the lottery terminal 100 and the central controller 102. The lottery terminal processor circuit is operable to execute such communicated events, messages or commands in conjunction with the operation of the lottery terminal 100. Moreover, the processor circuit of the central controller 102 is configured to transmit and receive events, messages, commands or any other suitable data or signal between the central controller 102 and each of the individual lottery terminals 100. In some embodiments, one or more of the functions of the central controller 102 may be performed by one or more lottery terminal processor circuits. Moreover, in some embodiments, one or more of the functions of one or more lottery terminal processor circuits as disclosed herein may be performed by the central controller 102.

A wireless access point 106 may provide wireless access to the communications network 104. The wireless access point 106 may be connected to the communications network 104 as illustrated in FIG. 1, or may be connected directly to the central controller 102 or another server connected to the communication network 104. A lottery terminal 100 may communicated through a wired connection with the communication network 104, via a wireless link 118 between the lottery terminal 100 and the wireless access point 106, and/or via a direct wireless link 120 between the lottery terminal 100 and the lottery network server 114, for example.

A player tracking server 108 may also be connected through the communication network 104. The player tracking server 108 may manage a player tracking account that tracks the player's gameplay and spending and/or other player preferences and customizations, manages loyalty awards for the player, manages funds deposited or advanced on behalf of the player, and other functions. Player information managed by the player tracking server 108 may be stored in a player information database 110.

Historically, lottery games may have a payout percentage of about 50%, meaning that 50% of the amount wagered is paid out in winnings. Because of this relative low payout percentage, many potential players may be disinclined to participate. For example, slot machine and casino gaming historically may have a payout percentage of about 85%. For many demographics, particularly younger players, lottery participation is focused on either low-level scratch off play, with frequent, but small payouts, or wide area jackpots, such as Powerball or Mega Millions, particularly when the potential jackpot is extremely large, e.g. in the hundreds of millions. Between these two extremes, there is relatively low participation among certain demographics.

To increase the level of instant gratification, a secondary progressive lottery game may be added to a ticket for a primary lottery game. The primary lottery game may have a plurality of game elements and may be resolved instantly, or at a predetermined later time independently of the resolution of the secondary lottery game. The game elements for the primary lottery game may be selected by the player, or may be randomly selected or predetermined. The secondary lottery game may include an identifier that, in combination with a triggering condition being satisfied, may resolve the secondary lottery game independently of the resolution of the primary lottery game. The identifier may be an alphanumeric code, and may include additional information, such as a date or date range when the ticket was sold, a location where the ticket was sold, or other additional information.

In some embodiments, a portion of the wager for the primary lottery game is credited to a prize pool for the secondary lottery game. If the primary lottery game has a relatively high volume, the portion of the wager can be relatively small, because the volume of the wagers may still grow the prize pool substantially in a short period of time. The secondary lottery game may have a predetermined prize pool level, where all or a portion of the prize pool is paid out when the prize pool reaches the predetermined prize pool level. The predetermined prize pool level may be selected randomly or semi-randomly, and may be selected within a predetermined range. When the prize pool predetermined prize pool level, the next lottery ticket to be issued that includes an identifier for the secondary lottery game may win the secondary lottery game prize, which may be all or a portion of the prize pool. In another example, an award may be paid out periodically, such as at a random time once every hour or at a random time once every day. The secondary lottery game can also be marketed to inform players of the frequency and size of secondary lottery game wins in particular regions. The player can receive the award for the secondary lottery game instantly and without resolving the primary lottery game, which may be resolved later.

By keeping the portion of the wager that is credited to the secondary lottery game prize pool relatively small, the overall payout and profit margin of the primary lottery game may be minimally affected. In addition, if the secondary lottery game increases participation in the primary lottery game, the overall profitability of the primary lottery game may be increased, despite the nominal decrease in profit margin for each individual lottery ticket. For example, for a $1 primary lottery game ticket, $0.50 may be paid out in winnings and $0.50 may be retained. For a high volume primary lottery game, crediting $0.01 of the wager, either through decreasing the primary game payout or decreasing the amount retained, may result in a substantial secondary lottery game prize pool, which can be paid out instantly.

By providing a second opportunity to win with instant gratification, the secondary lottery game may drive participation in the primary lottery game and increase overall revenue and profits for the primary lottery game. In particular, the instant gratification aspect may drive play from demographics that have traditionally lower participation rates, such as younger players. While a primary game may be resolved daily or weekly, e.g., through a drawing, providing a secondary progressive jackpot feature provides an opportunity for substantial wins at a time that a lottery ticket is issued, which may incentivize players to purchase primary game lottery tickets. By varying the sizes and frequencies of the progressive jackpot wins, players may be provided with additional instant win opportunities without adversely impacting the increment or hold percentage for the primary lottery game. In addition, by tying eligibility for the progressive jackpot feature to player status, players may be incentivized to register players and drive player loyalty. As a result, these and other embodiments may provide a unique technical solution the technical problem of incentivizing increased participation in lottery games among certain demographics without upsetting the underlying financial expectations of those lottery games.

To drive participation in the primary lottery game, each lottery terminal 100 may include an identifier, such as a sign, that identifies the lottery terminal 100 as offering the primary lottery game with the secondary lottery game progressive jackpot feature. In some embodiments, the sign may include information regarding the current level of the jackpot and/or historical information regarding previous awards.

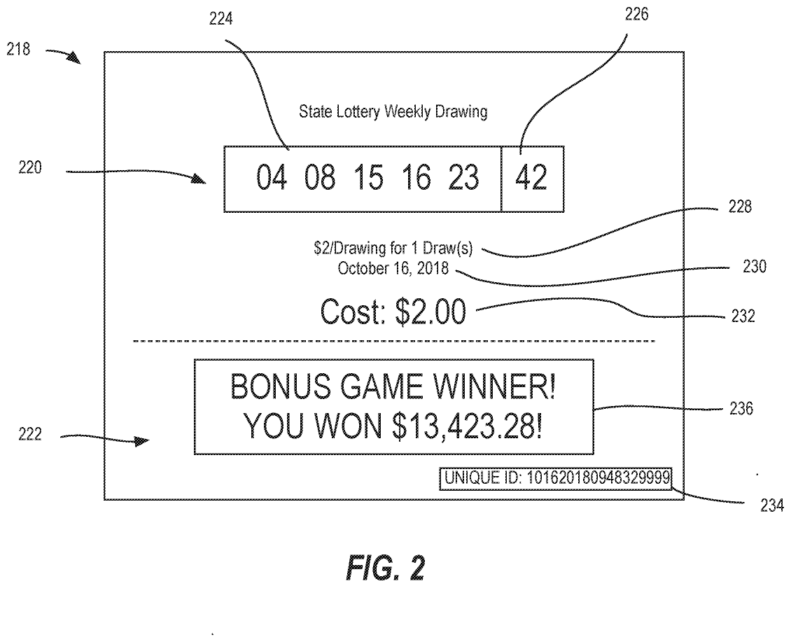

FIG. 2 illustrates a lottery ticket 218 having a primary lottery game 220 having a plurality of game elements and a secondary lottery game 222 having a progressive jackpot feature, according to some embodiments. The primary lottery game 220 in this embodiment includes a plurality of drawing numbers 224 and a special drawing number 226. Based on these selected drawing numbers 224 and special drawing number 226, the primary lottery game 220 may be resolved and a prize awarded based on some or all of the drawing number 224 and/or special drawing number 226 matching numbers that are drawn during a weekly drawing. Additional information, including game rules 228, date stamp 230, and a wager amount 232 may also be printed on the lottery ticket 218.

The lottery ticket 218 also includes a secondary lottery game 222 with a progressive jackpot feature. In this embodiment, the secondary lottery game 222 includes a unique identifier, which may be indicated by a unique identifier indicium 234. The unique identifier can be randomly or semi-randomly generated, and which also may include time, date, or other information. The unique identifier indicium 234 can be printed on the lottery ticket 218 or otherwise displayed to a user or operator, or may be omitted, as desired. In this embodiment, the secondary lottery game is resolved when the lottery ticket 218 is printed, and in this example, the lottery ticket 218 includes an award message 236 informing the holder of the lottery ticket 218 of an award for the secondary lottery game 222. In this example, the secondary lottery game 222 is resolved independently of the primary lottery game 220. Similarly, the primary lottery game 220, which is resolved at a later time (e.g., during a weekly drawing), is resolved independently of the secondary lottery game 222. It should be understood that many different types of lottery games may be used for the primary lottery game 220 and/or the secondary lottery game 222, as desired. These types of lottery games include number drawing games, scratch-off instant win games, skill-based or semi-skill based games, or other types of games.

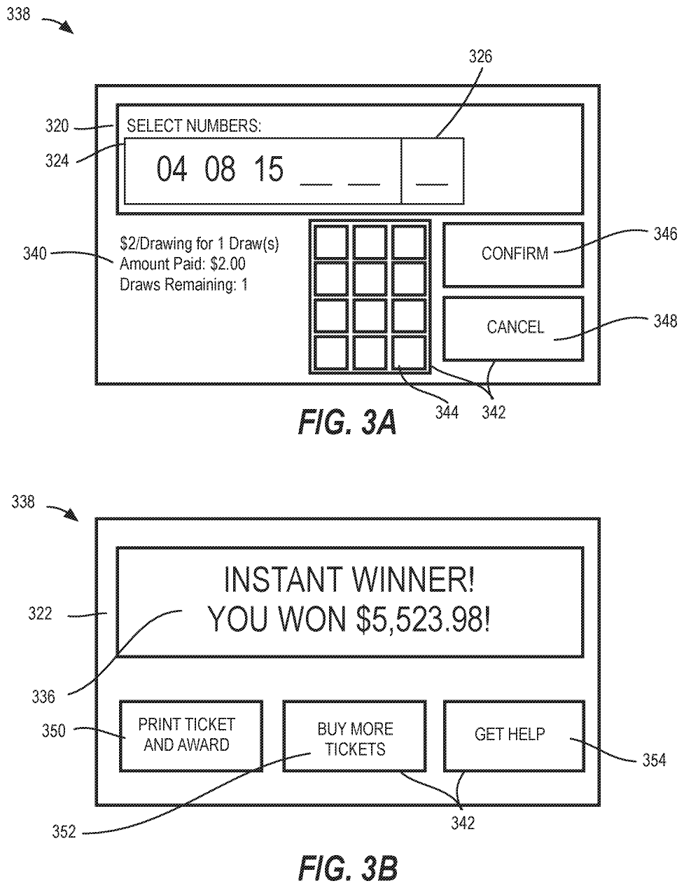

While the embodiment of FIG. 2 is a physical lottery ticket, it should be understood that a lottery transaction may be performed entirely electronically by providing an electronic lottery ticket at a lottery terminal, such as the lottery terminals 100 of FIG. 1. In this regard, FIGS. 3A and 3B illustrate a graphical user interface (GUI) 338 for providing a progressive jackpot feature at a lottery terminal according to some embodiments.

Referring now to FIG. 3A, a primary lottery game 320 is provided with a drawing number input field 324 and a special drawing number input field 326, similar to the primary lottery game 220 of FIG. 2. The GUI 338 may include additional information 340, such as game rules for example, and a plurality of input elements 342 for receiving user input, such as user input corresponding to a lottery entry request for example. In this example, the input elements 342 include a keypad for entering numbers into the drawing number input field 324 and the special drawing number input field 326, a confirm button 346 to confirm an input selection, and a cancel button 348 to cancel the input selection. After submitting the drawing numbers and special drawing number for the primary lottery game 320, the GUI 338 may display an award message 336 for a secondary lottery game 322, as shown in FIG. 3B. Additional input elements 342, such as a print button 350 for printing a ticket for redeeming the award, an additional purchase button 352 for using a portion of the winnings from the secondary lottery game 322 to purchase more entries into the primary lottery game 320 or other lottery game, and a help button 354 for requesting assistance with redeeming the award and/or using other features of the GUI 338.

The lottery terminal may be embodied in a standalone computing device, such as a standalone terminal or kiosk operated by a merchant, for example, or in a consumer computing device, such as a phone, tablet, personal computer, or other stationary or mobile computing device. In this example, the GUI 338 of FIGS. 3A and 3B is provided at a mobile consumer device having a touchscreen user interface on a touchscreen display, but it should be understood that these and other features may be included in other devices within a lottery system as well.

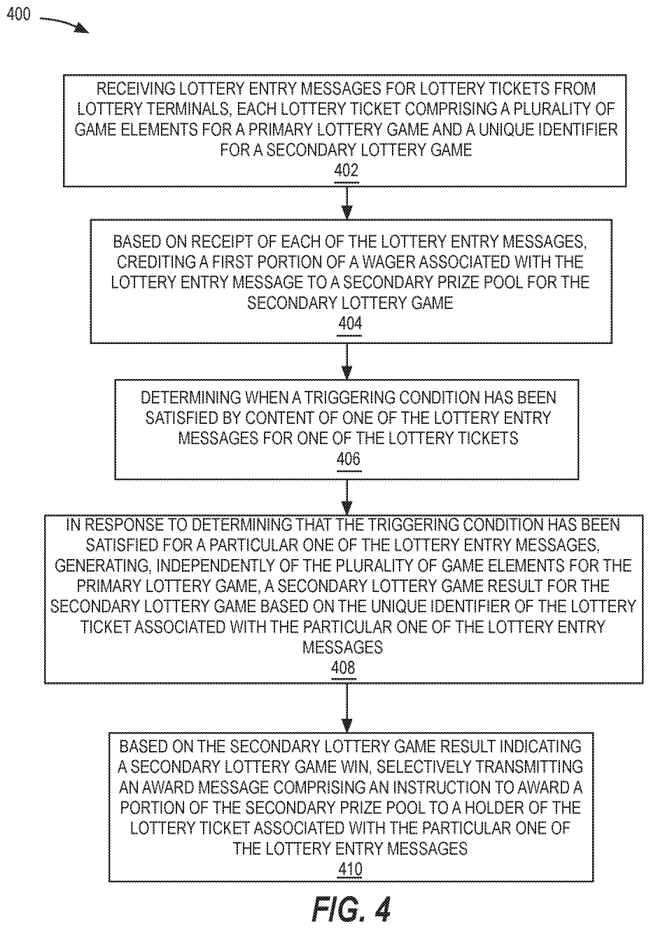

Referring now to FIG. 4, a flowchart illustrates operations of systems/methods according to some embodiments. The operations 400 include receiving lottery entry messages for lottery tickets from lottery terminals, each lottery ticket including a plurality of game elements for a primary lottery game and a unique identifier for a secondary lottery game (Block 402). In this embodiment, a primary game result for the primary lottery game is based on the plurality of game elements independently of the unique identifier for the secondary lottery game. The operations 400 further include, based on receipt of each of the lottery entry messages, crediting a first portion of a wager associated with the lottery entry message to a secondary prize pool for the secondary lottery game (Block 404). In some embodiments, prior to crediting the portion of the wager to the secondary prize pool for each of the lottery entry messages, the operations may further include determining whether a player status identifier contained in the lottery entry message is a predetermined player status, with the crediting the portion of the wager to the secondary prize pool being performed responsive to determining that the player status identifier is the predetermined player status.

The operations 400 further include determining when a triggering condition has been satisfied by content of one of the lottery entry messages for one of the lottery tickets (Block 406). In some embodiments, the triggering condition may be determined to be satisfied based on the secondary prize pool being above a predetermined threshold. The predetermined threshold may be determined based on a result generated by a random number generator, for example. In some embodiments, determining that the triggering condition has been satisfied may be based on determining that the player status identifier is the predetermined player status, and based on determining that the secondary prize pool is above a predetermined threshold. In some embodiments, determining that the triggering condition has been satisfied may be based on determining that a player status identifier contained in the particular one of the lottery entry messages is a predetermined player status, and based on determining that the secondary prize pool is above a predetermined threshold.

The operations 400 further include, in response to determining that the triggering condition has been satisfied for a particular one of the lottery entry messages, generating, independently of the plurality of game elements for the primary lottery game, a secondary lottery game result for the secondary lottery game based on the unique identifier of the lottery ticket associated with the particular one of the lottery entry messages (Block 408). In some embodiments, generating the secondary lottery game result based on the unique identifier may include automatically indicating a secondary game win (such as a portion of the secondary prize pool) to the holder of the lottery ticket comprising the unique identifier associated with the lottery entry message that satisfied the triggering condition. In other embodiments, the unique identifier may be used as an additional game element in the secondary lottery game, where generating the secondary lottery game result is based on the unique identifier satisfying a game condition or game rule for the secondary lottery game, and/or based on the unique identifier satisfying another additional condition or rule.

The operations 400 further include, based on the secondary lottery game result indicating a secondary lottery game win, selectively transmitting an award message including an instruction to award a portion of the secondary prize pool to a holder of the lottery ticket associated with the particular one of the lottery entry messages (Block 410). In some embodiments, the award message may be directed to a device identifier obtained from the particular one of the lottery entry messages for a particular one of the lottery terminals, and the instruction to award the portion of the secondary prize pool may include an instruction to the particular one of the lottery terminals to dispense, via an electronically controlled dispenser apparatus, a physical item redeemable for a monetary value based on the portion of the secondary prize pool. In some embodiments, the instruction to award the portion of the secondary prize pool may include an instruction to award the entire secondary prize pool to the holder of a particular one of the lottery tickets associated with the particular one of the lottery entry messages. In some embodiments, the award message may be received at a particular one of the lottery terminals in response to determining that the triggering condition has been satisfied for the particular one of the lottery entry messages from the particular one of the lottery terminals and that the one of the lottery entry messages is the particular one of the lottery entry messages. In response to receiving the award message, the operations may further include awarding, at the particular one of the lottery terminals, the portion of the secondary prize pool to the holder of a particular one of the lottery tickets associated with the particular one of the lottery entry messages.

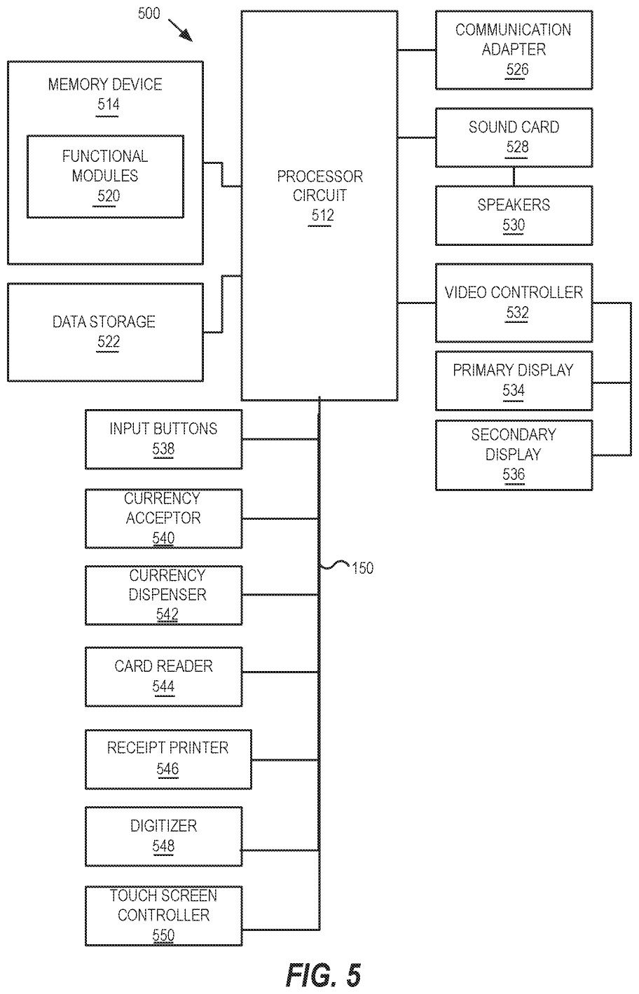

Lottery terminals, lottery servers, and other components of the systems disclosed herein, such as components of the system 10 of FIG. 1, for example, may include a number of standard features, many of which are illustrated in FIG. 5. For example, referring to FIG. 5, a computing device 500 may be embody or may be a component of a number of the devices discloses herein, including, for example, the lottery network server 112 of FIG. 1, the lottery terminal 100 of FIG. 1, or any number of other embodiments described herein.

In this regard, FIG. 5 is a block diagram of a computing device 500 that illustrates logical and functional relationships between various components of the computing device 500. The computing device 500 may include a processor circuit 512 that controls operations of the computing device 500. Although illustrated as a single processor circuit, multiple special purpose and/or general purpose processors and/or processor cores may be provided in the computing device 500. For example, the computing device 500 may include one or more of a video processor, a signal processor, a sound processor and/or a communication controller that performs one or more control functions within the computing device 500. The processor circuit 512 may be variously referred to as a “controller,” “microcontroller,” “microprocessor” or simply a “computer.” The processor circuit may further include one or more application-specific integrated circuits (ASICs).

Various components of the computing device 500 are illustrated in FIG. 5 as being connected to the processor circuit 512. It will be appreciated that the components may be connected to the processor circuit 512 through a system bus 150, a communication bus and controller, such as a USB controller and USB bus, a network interface, or any other suitable type of connection.

The computing device 500 further includes a memory device 514 that stores one or more functional modules 520. The memory device 514 may store the functional modules 520 and other program code and instructions, executable by the processor circuit 512, to control the computing device 500. The memory device 14 may also store other data such as image data, event data, player input data, random or pseudo-random number generators, pay-table data or information and applicable game rules that relate to the play of the gaming device. The memory device 514 may include random access memory (RAM), which can include non-volatile RAM (NVRAM), magnetic RAM (ARAM), ferroelectric RAM (FeRAM) and other forms as commonly understood in the gaming industry. In some embodiments, the memory device 514 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The computing device 500 may further include a data storage device 522, such as a hard disk drive or flash memory. The data storage device 522 may store program data, player data, audit trail data or any other type of data. The data storage device 522 may include a detachable or removable memory device, including, but not limited to, a suitable cartridge, disk, CD ROM, DVD or USB memory device.

The computing device 500 may include a communication adapter 526 that enables the computing device 500 to communicate with remote devices over a wired and/or wireless communication network, such as a local area network (LAN), wide area network (WAN), cellular communication network, or other data communication network. The communication adapter 526 may further include circuitry for supporting short range wireless communication protocols, such as Bluetooth and/or near field communications (NFC) that enable the computing device 500 to communicate, for example, with a mobile communication device operated by a player.

The computing device 500 may include a sound card 528 and speakers 530 for providing audio content and/or feedback to a user, and may include a video 532 connected to a primary display 534 and/or a secondary display 536 for providing video content and/or feedback to the user. The computing device 500 may include one or more internal or external communication ports that enable the processor circuit 512 to communicate with and to operate with internal or external peripheral devices, such as input buttons 538, a currency acceptor 540, a currency dispenser 542, a card reader 544, a receipt printer 546, and or other components. A digitizer 548 and/or touch screen controller 550 may enable touchscreen functionality for the primary display 534, secondary display 536 or other displays. Other internal or external peripheral devices may include eye tracking devices, position tracking devices, cameras, accelerometers, arcade sticks, bar code readers, biometric input devices, bonus devices, button panels, card readers, bill and/or coin acceptor/dispensers, coin hoppers, other displays or video sources, expansion buses, information panels, keypads, lights, mass storage devices, microphones, motion sensors, motors, printers, reels, SCSI ports, solenoids, thumb drives, ticket readers, trackballs, touchpads, wheels, and wireless communication devices. In some embodiments, internal or external peripheral devices may communicate with the processor circuit 12 through a universal serial bus (USB) hub (not shown) connected to the processor circuit 12.

In some embodiments, a computing device 500 may be implemented by a desktop computer, a laptop personal computer, a personal digital assistant (PDA), portable computing device, or other computerized platform. In some embodiments, the computing device 500 may be operable over a wireless network, such as part of a wireless gaming system. In such embodiments, the computing device 500 may be a hand held device, a mobile device or any other suitable wireless device. It should also be understood that a computing device 500 as disclosed may include mechanical or electro-mechanical elements. It should be appreciated that a computing device 500 as disclosed herein may be a device that has obtained approval from a regulatory agency, such as a financial regulatory agency or regulatory gaming commission, or may be a device that has not obtained approval from a regulatory agency.

Embodiments described herein may be implemented in various configurations for computing device 500, including but not limited to: (1) a dedicated computing device, wherein the computerized instructions for controlling the device are provided with the device prior to delivery or installation of the device; and (2) a changeable computing device 500, where the computerized instructions for controlling the device are downloadable to the device through a data network where the device is located and/or installed. In some embodiments, the computerized instructions for controlling the device are executed by at least one central server, central controller or remote host. In such a “thin client” embodiment, the central server remotely controls the functions of the device (or other suitable interfaces) and the computing device 500 is utilized to execute such functions (or suitable interfaces) and receive one or more inputs or commands from a user. In another embodiment, the computerized instructions for controlling the device are communicated from the central server, central controller or remote host to a local processor circuit and memory devices. In such a “thick client” embodiment, the local processor circuit executes the communicated computerized instructions to control the functions of the device (or other suitable interfaces) provided to a user.

In some embodiments, one or more computing device 500 in a system may be thin client devices and one or more computing device 500 in the system may be thick client devices. In another embodiment, certain functions of the computing device 500 are implemented in a thin client environment and certain other functions of the computing device 500 are implemented in a thick client environment.

The present disclosure contemplates a variety of different computing systems each having one or more of a plurality of different features, attributes, or characteristics. It should be appreciated that a “computing system” as used herein refers to various configurations of: (a) one or more central servers, central controllers, or remote hosts; (b) one or more computing devices; and/or (c) one or more personal computing devices, such as desktop computers, laptop computers, tablet computers or computing devices, personal digital assistants (PDAs), mobile telephones such as smart phones, and other mobile computing devices.

In certain such embodiments, computerized instructions are executed by the central server, central controller, or remote host. In such “thin client” embodiments, the central server, central controller, or remote host remotely controls the certain functionality (or other suitable interfaces) displayed by the computing devices, and the computing device is utilized to display such functionality (or suitable interfaces) and to receive one or more inputs or commands. In other such embodiments, computerized instructions for controlling such functionality displayed by the computing device are communicated from the central server, central controller, or remote host to the computing device and are stored in at least one memory device of the computing device. In such “thin client” embodiments, the at least one processor circuit of the computing device executes the computerized instructions to control any games (or other suitable interfaces) displayed by the computing device.

In some embodiments in which the computing system includes: (a) a computing device configured to communicate with a central server, central controller, or remote host through a data network; and/or (b) a plurality of computing devices configured to communicate with one another through a data network, the data network is an internet or an intranet. In certain such embodiments, an internet browser of the computing device is usable to access an internet page from any location where an internet connection is available. In one such embodiment, after the internet page is accessed, the central server, central controller, or remote host identifies a user prior to enabling that player to use certain functionality of the computing system. In one example, the central server, central controller, or remote host identifies the user by requiring a user account of the user to be logged into via an input of a unique username and password combination assigned to the user. It should be appreciated, however, that the central server, central controller, or remote host may identify the user in any other suitable manner, such as by validating a user tracking identification number associated with the user; by reading a user tracking card or other smart card inserted into a card reader; by validating a unique user identification number associated with the user by the central server, central controller, or remote host; or by identifying the computing device, such as by identifying the MAC address or the IP address of the internet facilitator. In various embodiments, once the central server, central controller, or remote host identifies the user, the central server, central controller, or remote host enables placement of one or more wagers on one or more plays of one or more primary or base games and/or one or more secondary or bonus games, and displays those plays via the internet browser of the computing device.

It should be appreciated that the central server, central controller, or remote host and the computing device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of computing devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with a machine readable instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A lottery server system comprising:
a server processor circuit; and
a server memory coupled to the server processor circuit, the server memory comprising machine-readable instructions that, when executed by the server processor circuit, cause the server processor circuit to:
receive lottery entry messages for lottery tickets from lottery terminals, each lottery ticket comprising a plurality of game elements for a primary lottery game and a unique identifier for a secondary lottery game, wherein a primary game result for the primary lottery game is based on the plurality of game elements independently of the unique identifier for the secondary lottery game;
based on receipt of each of the lottery entry messages, credit a first portion of a wager associated with the lottery entry message to a secondary prize pool for the secondary lottery game;
determine when a triggering condition has been satisfied by content of one of the lottery entry messages for one of the lottery tickets;
in response to determining that the triggering condition has been satisfied for a particular one of the lottery entry messages, generate, independently of the plurality of game elements for the primary lottery game, a secondary lottery game result for the secondary lottery game based on the unique identifier of the lottery ticket associated with the particular one of the lottery entry messages; and
based on the secondary lottery game result indicating a secondary lottery game win, selectively transmit an award message comprising an instruction to award a portion of the secondary prize pool to a holder of the lottery ticket associated with the particular one of the lottery entry messages.

2. The lottery server system of claim 1, wherein the award message is directed to a device identifier obtained from the particular one of the lottery entry messages for a particular one of the lottery terminals, and
wherein the instruction to award the portion of the secondary prize pool further comprises an instruction to the particular one of the lottery terminals to dispense, via an electronically controlled dispenser apparatus, a physical item redeemable for a monetary value based on the portion of the secondary prize pool.

3. The lottery server system of claim 1, wherein the instruction to award the portion of the secondary prize pool comprises an instruction to award the entire secondary prize pool to the holder of a particular one of the lottery tickets associated with the particular one of the lottery entry messages.

4. The lottery server system of claim 1, wherein the triggering condition is determined to be satisfied based on the secondary prize pool being above a predetermined threshold.

5. The lottery server system of claim 4, the server memory further comprising machine-readable instructions that, when executed by the server processor circuit, cause the server processor circuit to determine the predetermined threshold based on a result generated by a random number generator.

6. The lottery server system of claim 1, further comprising a plurality of lottery terminals in communication with the server processor circuit, each lottery terminal comprising:
an input device;
a display device;
a device processor circuit; and
a device memory coupled to the device processor circuit, the device memory comprising machine-readable instructions that, when executed by the device processor circuit cause the device processor circuit to:
receive, at the input device, a user input corresponding to a lottery entry request;
in response to receiving the lottery entry request, transmit one of the lottery entry messages to the server processor circuit,
receive, in response to the server processor circuit determining that the triggering condition has been satisfied for the particular one of the lottery entry messages from the lottery terminal and that the one of the lottery entry messages is the particular one of the lottery entry messages, the award message; and
in response to receiving the award message, award the portion of the secondary prize pool to the holder of a particular one of the lottery tickets associated with the particular one of the lottery entry messages.

7. The lottery server system of claim 1, the server memory further comprising machine-readable instructions that, when executed by the server processor circuit, cause the server processor circuit to:
for each of the lottery entry messages, prior to crediting the portion of the wager to the secondary prize pool, determine whether a player status identifier contained in the lottery entry message is a predetermined player status, wherein crediting the portion of the wager to the secondary prize pool is performed responsive to determining that the player status identifier is the predetermined player status.

8. The lottery server system of claim 7, the server memory further comprising machine-readable instructions that, when executed by the server processor circuit, cause the server processor circuit to:
determine that the triggering condition has been satisfied based on determining that the player status identifier is the predetermined player status, and based on determining that the secondary prize pool is above a predetermined threshold.

9. The lottery server system of claim 1, the server memory further comprising machine-readable instructions that, when executed by the server processor circuit, cause the server processor circuit to:
determine that the triggering condition has been satisfied based on determining that a player status identifier contained in the particular one of the lottery entry messages is a predetermined player status, and based on determining that the secondary prize pool is above a predetermined threshold.

10. A method comprising:
receiving lottery entry messages for lottery tickets from lottery terminals, each lottery ticket comprising a plurality of game elements for a primary lottery game and a unique identifier for a secondary lottery game, wherein a primary game result for the primary lottery game is based on the plurality of game elements independently of the unique identifier for the secondary lottery game;
based on receipt of each of the lottery entry messages, crediting a first portion of a wager associated with the lottery entry message to a secondary prize pool for the secondary lottery game;
determining when a triggering condition has been satisfied by content of one of the lottery entry messages for one of the lottery tickets;
in response to determining that the triggering condition has been satisfied for a particular one of the lottery entry messages, generating, independently of the plurality of game elements for the primary lottery game, a secondary lottery game result for the secondary lottery game based on the unique identifier of the lottery ticket associated with the particular one of the lottery entry messages; and
based on the secondary lottery game result indicating a secondary lottery game win, selectively transmitting an award message comprising an instruction to award a portion of the secondary prize pool to a holder of the lottery ticket associated with the particular one of the lottery entry messages.

11. The method of claim 10, wherein the award message is directed to a device identifier obtained from the particular one of the lottery entry messages for a particular one of the lottery terminals, and
wherein the instruction to award the portion of the secondary prize pool further comprises an instruction to the particular one of the lottery terminals to dispense, via an electronically controlled dispenser apparatus, a physical item redeemable for a monetary value based on the portion of the secondary prize pool.

12. The method of claim 10, wherein the instruction to award the portion of the secondary prize pool comprises an instruction to award the entire secondary prize pool to the holder of a particular one of the lottery tickets associated with the particular one of the lottery entry messages.

13. The method of claim 10, wherein the triggering condition is determined to be satisfied based on the secondary prize pool being above a predetermined threshold.

14. The method of claim 13, further comprising determining the predetermined threshold based on a result generated by a random number generator.

15. The method of claim 10, further comprising:
receiving, at a particular one of the lottery terminals in response to determining that the triggering condition has been satisfied for the particular one of the lottery entry messages from the particular one of the lottery terminals and that the one of the lottery entry messages is the particular one of the lottery entry messages, the award message; and
in response to receiving the award message, awarding, at the particular one of the lottery terminals, the portion of the secondary prize pool to the holder of a particular one of the lottery tickets associated with the particular one of the lottery entry messages.

16. The method of claim 10, further comprising:
for each of the lottery entry messages, prior to crediting the portion of the wager to the secondary prize pool, determining whether a player status identifier contained in the lottery entry message is a predetermined player status, wherein crediting the portion of the wager to the secondary prize pool is performed responsive to determining that the player status identifier is the predetermined player status.

17. The method of claim 16, further comprising:
determining that the triggering condition has been satisfied based on determining that the player status identifier is the predetermined player status, and based on determining that the secondary prize pool is above a predetermined threshold.

18. The method of claim 10, further comprising:
determining that the triggering condition has been satisfied based on determining that a player status identifier contained in the particular one of the lottery entry messages is a predetermined player status, and based on determining that the secondary prize pool is above a predetermined threshold.

19. A lottery terminal comprising:
an input device;
an electronically controlled dispenser apparatus;
a processor circuit; and
a memory coupled to the processor circuit, the memory comprising machine-readable instructions that, when executed by the processor circuit cause the processor circuit to:
receive, at the input device, an indication of a wager for a lottery ticket, the lottery ticket comprising a plurality of game elements for a primary lottery game and a unique identifier for a secondary lottery game, wherein a primary game result for the primary lottery game is based on the plurality of game elements independently of the unique identifier for the secondary lottery game;
in response to receiving the indication of the wager, transmit a lottery entry message comprising the unique identifier to a lottery server;
in response to the lottery server crediting a portion of the wager to a secondary prize pool for a secondary game based on the lottery entry message and determining that a triggering condition has been satisfied for the lottery entry message, receive, from the lottery server, an award message comprising an instruction to award a portion of the secondary prize pool to a holder of the lottery ticket; and
in response to receiving the award message, dispense, via the electronically controlled dispenser apparatus, a physical item redeemable for a monetary value based on the portion of the secondary prize pool.

20. The lottery terminal of claim 19, wherein awarding the portion of the secondary prize pool comprises awarding the entire secondary prize pool to the holder of the lottery ticket.
